(19) United States
(12) Patent Application Publication
(10) Pub. No.: US 2015/0370552 A1
(43) Pub. Date: Dec. 24, 2015

(54) SUBSCRIBER DEFINED DYNAMIC EVENTING

(71) Applicant: Microsoft Technology Licensing, LLC, Redmond, WA (US)

(72) Inventors: Thomas Hejlsberg, Copenhagen (DK); Esben Nyhuus Kristoffersen, Copenhagen (DK)

(21) Appl. No.: 14/496,117

(22) Filed: Sep. 25, 2014

Related U.S. Application Data
(60) Provisional application No. 62/015,075, filed on Jun. 20, 2014.

(51) Int. Cl. G06F 9/445

(52) U.S. Cl. CPC G06F 8/67

(57) ABSTRACT

A computer-implemented method of modifying execution behavior of a programmatic unit of source code is provided. The method includes loading the programmatic unit of source code and determining whether at least one customization is defined for the programmatic unit. The at least one customization is selectively executed based on whether a prerequisite of the customization is satisfied.

### CROSS-REFERENCE TO RELATED APPLICATIONS

The present application is based on and claims the benefit of U.S. Provisional Patent Application Ser. No. 62/015,075, filed Jun. 20, 2014, the content of which is hereby incorporated in its entirety.

### BACKGROUND

Computer systems are currently in wide use. Some such systems are customized (some significantly) before they are deployed at an end user's site. By way of example, some such computer systems include business systems, such as customer relations management (CRM) systems, enterprise resource planning (ERP) systems, line-of-business (LOB) systems, etc. In these types of systems, a general business system is first purchased by a user or customer, and the user or customer often makes customizations, extensions or other modifications to that general business system, in order to obtain their own customized deployment.

Typically, such customizations have been provided either through direct modification of the source code or by having the original software author insert a number of hook-points in the software source code.

Direct modification to source code provides the most flexibility for customization. With such modifications, any change can be made to the software. The limitation of this approach becomes apparent when the original software needs to be modified, such as when an update or patch is required. In such instances, the modifications to the original source code may no longer interoperate with various customization. Thus, the developer must return to the modifications and carefully port or modify each of the previously-generated customizations to the updated/patched source code. In most cases, this manual and tedious process tends to require significant developer time and thus be very expensive.

Providing a number of hook-points in the original source code is another way in which customizations can be implemented. The author(s) of the original application can insert a number of hook-points where callouts are made. This is known as eventing. In eventing, the original author(s) will insert one or more callouts at defined positions in the source code. Each such callout will call out to a specified event passing certain pre-defined parameters. Additionally, at run-time, the callout will check to see if there are any subscribers to the event. If there are subscribers to the event, then the subscriber's code is loaded and executed. One limitation of standard eventing is that the original author(s) of the software may not have provided a hook-point at the precise position in the code that the developer, who needs to apply a customization, requires. Further, the original author(s) will define the contract or parameters of the callout. In some instances, if the contract or parameters of the callout are changed by the original author(s) via an upgrade or patch, customizations reliant upon the callout may fail.

### SUMMARY

A computer-implemented method of modifying execution behavior of a programmatic unit of source code is provided. The method includes loading the programmatic unit of source code and determining whether at least one customization is defined for the programmatic unit. The at least one customization is selectively executed based on whether a prerequisite of the customization is satisfied.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of an environment in which a developer provides customizations relative to original source code in accordance with an embodiment of the present invention.

FIG. 2, is a diagrammatic view of a processor executing a software application via an execution pipeline.

FIG. 3 is a computer-implemented method of executing a software application in accordance with an embodiment of the present invention.

FIG. 4 is a method of defining a subscriber dynamic event in accordance with an embodiment of the present invention.

FIG. 5 shows a block diagram of one exemplary architecture in which embodiments of the present invention are particularly useful.

FIG. 6 shows a cloud computing architecture in which embodiments of the present invention are useful.

FIGS. 7-10 show various mobile devices in which embodiments of the present invention are useful.

FIG. 11 is a block diagram of one illustrative computing environment.

### DETAILED DESCRIPTION

Embodiments of the present invention generally allow an arbitrary customization to be applied to virtually any executable unit of code, including methods, functions, modules, and even one or more individual lines of source code, without modifying the original source code. In accordance with embodiments described herein, the platform executing the original source code will provide “dynamic hooks” that allow a developer generating customizations relative to the original source code to subscribe to one or more events that the developer defines. As long as the prerequisite for the defined event is still valid, changes to the original source code from software manufacturer, such as updates and/or patches, can be provided without affecting operation of the customization(s).

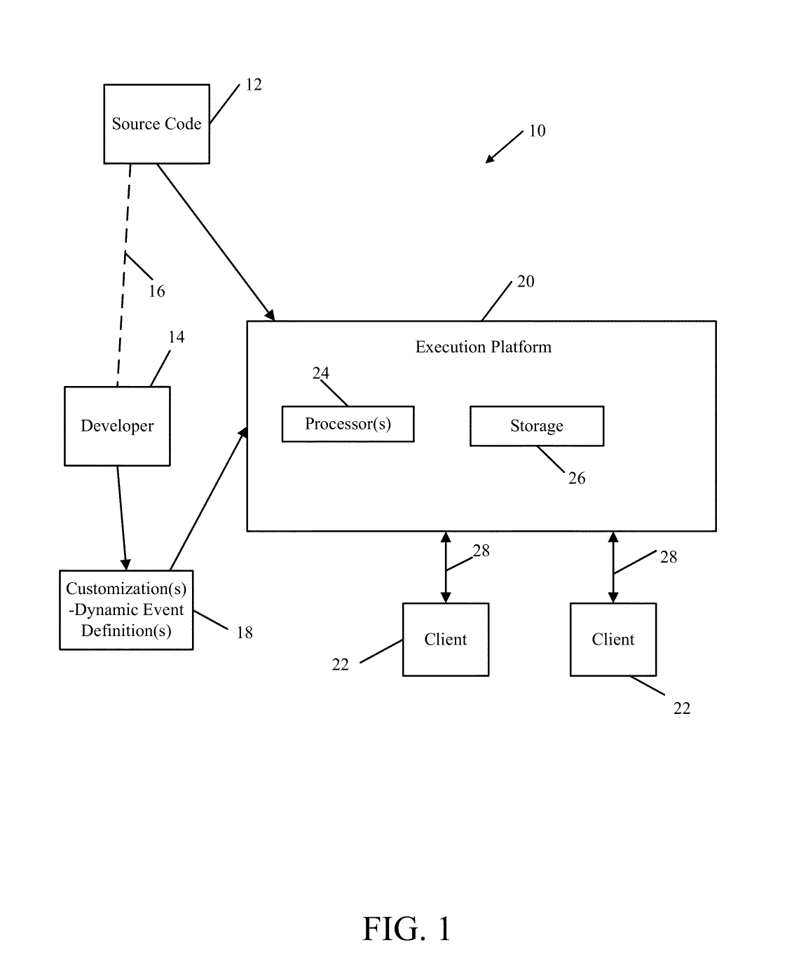

FIG. 1 is a diagrammatic view of an environment in which a developer 14 provides customizations 18 relative to original source code 12 in accordance with an embodiment of the present invention. In environment 10, source code 12 has been obtained from a source code publisher, such as Microsoft Corporation. “Source code” as used herein is intended to mean a textual listing of commands that are to be compiled or assembled into a computer executable program. Source code can be provided in any of a number of now known or later developed programming languages. Typically, source code will be entered, line by line, by one or more authors of the software product.

As described above, many software products are intended to be customized before being deployed by an end user. One example of such as software product is an enterprise resource planning system. However, embodiments of the present invention are applicable whenever it is desirable to change the behavior of a software product without changing the source code of the software product. In the example shown in FIG. 1, developer 14 has access to source code 12 as indicated by dashed line 16. Such access can be via any suitable manner including online access or offline access, such as a hardcopy of the source code. The source code is used as a reference. In order to customize the software product, developer 14 reviews source code 12 and generates one or more customizations 18. These customizations 18 are in the form of dynamic event definitions, as will be described in greater detail below. The customizations 18 are provided to execution platform 20, which will generally already have source code 12 in its original, non-altered, state. Execution platform 20 is any suitable arrangement of hardware, software or combination thereof that is capable of receiving source code, generating machine-executable code based on the source code, and executing the machine executable code. As such, execution platform 20 may be a single personal computer, a group of servers operating in an enterprise, a single core of a device, or a large group of servers operating in a cloud computing environment. Execution platform 20 may include one or more processors 24 as well as a suitable storage component 26 to support programmatic compilation and/or execution.

Execution platform 20 executes original source code 12 along with customizations 18 to provide customized software operation to one or more clients 22 interacting with execution platform 20. Clients 22, in one example, are computers operably coupled to execution platform 20 via communication links 28 in order to allow clients 22 to interact with the software product being executed by execution platform 20. Links 28 can include any suitable communication links including wired or wireless communication through a LAN or WAN.

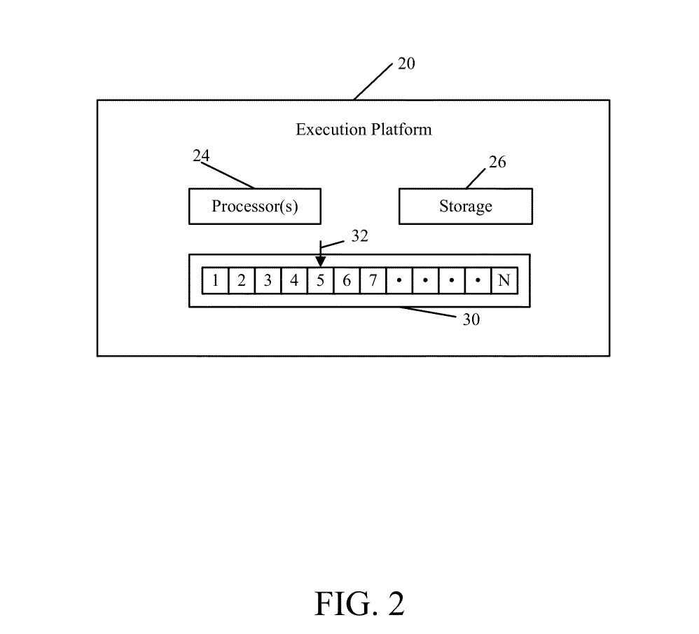

FIG. 2 is a diagrammatic view of a processor of an execution platform executing a software application via an execution pipeline 30. While pipeline 30 is shown as a linear pipeline including programmatic source units 1 . . . N, such simplification is provided to illustrate that programmatic execution typically steps through a sequence of commands. In the example shown in FIG. 2, programmatic execution is currently on unit 5, as indicated by pointer 32. Once execution of unit 5 is complete, processor 24 will begin to execute unit 6. However, prior to such execution, processor 24 will determine if any customizations have been attached or defined relative to programmatic unit 6. Such a customization, by virtue of its definition, will have an indication specifying whether it should run before unit 6, in place of unit 6, or after unit 6. Accordingly, execution platform 20 will execute code corresponding to the customization according to the customization definition, before, in place of, or after unit 6. Once programmatic unit 6 and any associated customizations have executed, execution platform moves on to programmatic unit 7. As used herein, programmatic units are intended to mean any executable line or lines of code, which line(s) may comprise a method, for example. Accordingly, since customizations can be injected prior to, in place of, or after any programmatic unit, embodiments of the present invention provide significant flexibility in that a developer can define a “hook” at any point in the source code.

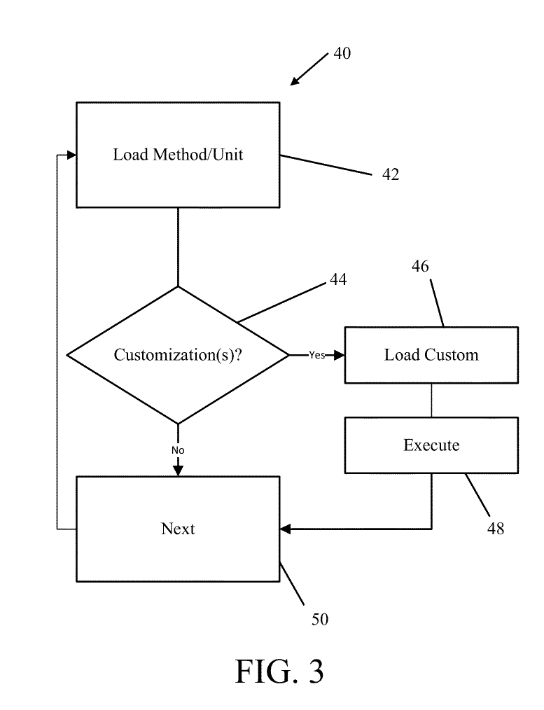

FIG. 3 is a method of executing a software application in accordance with an embodiment of the present invention. Method 40 begins at block 42 where processor 24 (shown in FIGS. 1 and 2) loads a method or programmatic unit. Next, at block 44, processor 24 checks to see if there are any customizations associated with the method or unit loaded at block 42. If so, control passes to block 46 where the customization associated with the loaded method or unit is loaded by processor 24. Next, based on the definition of the customization, processor 24 executes the customization at block 48 before, in place of, or after the method or unit loaded at block 42. In examples where the customization is not in place of the loaded method or unit, the loaded method or unit is also executed by processor 24 at block 48 before or after execution of the customization, as defined by the customization. Control then passes to block 50 where the next programmatic unit/method is loaded. As shown in FIG. 3, if a given method or programmatic unit does not have an associated customization, control passes from decision block 44 to block 50. Method 40 will continue looping until program execution is stopped or completed.

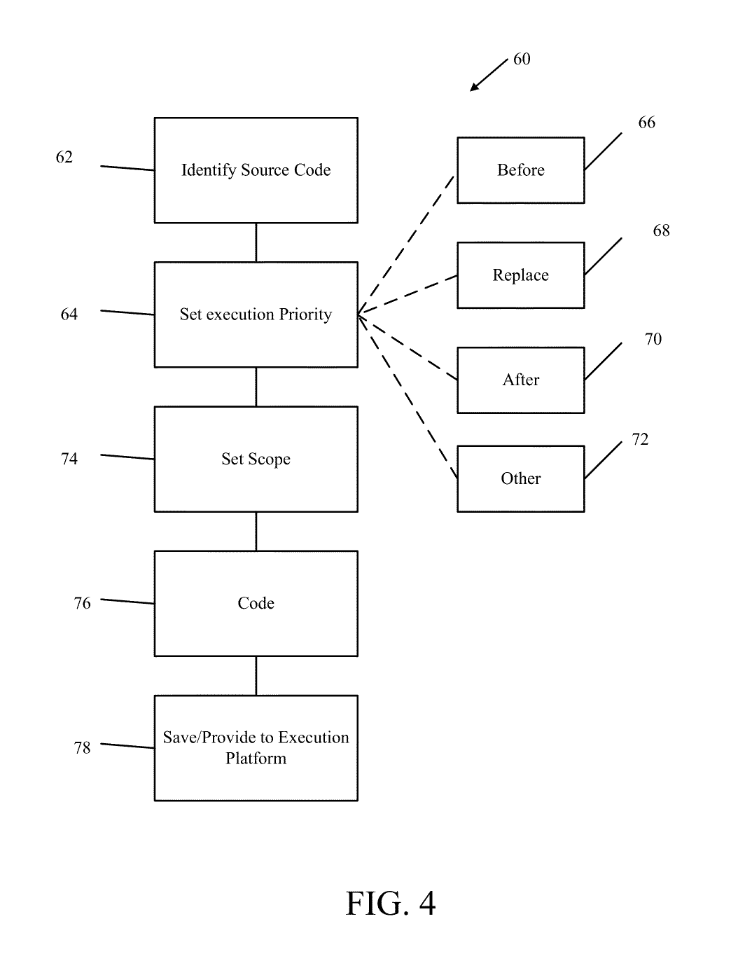

FIG. 4 is a method of defining a dynamic event in accordance with an embodiment of the present invention. Method 60 begins at block 62 where a developer identifies a particular unit of source code to which a customization will be associated. The unit of source code can be a function, method, module or individual line of source code. The identification of the unit of source code can be via a name of the function or module, or, in the case of an individual line of source code, an identification of one or more lines of source code preceding the selected line and an identification of one or more lines of source code following the selected line of source code. Next, at block 64, the developer chooses how the customization will execute relative to the original source code. For example, the customization may execute before 66, instead of 68, or after 70 the identified source code. Further, when a customization executes instead of the identified source code, the customization may run the identified source code as a sub-call from the customization, if desired. Additionally, other execution sequence indicators are also contemplated as indicated at block 72. For example, in the event that multiple customizations are to be executed before a selected unit of source code, one customization may be indicated as “absolutely first” or “absolutely last.” Next, at block 74, the developer indicates the scope of the customization. This scope indication will typically allow the customization to have access to variables and other information within the selected unit of source code. At block 76, the developer can provide code that uses some or all of the variables and other information in the selected unit of source code. This allows the original to change in all aspects as long as the subscribed variables remain unchanged. Further, linking to the variables “by name” provides the original developer with a way to deliberately break any contract a customization might have. In this way, the developer may simply change the name of the variables, which will require that customizations that rely on the original variable names will need to be revisited. Finally, at block 78, the customization is saved and provided to the execution platform for execution with the original, non-modified source code.

In the following example, Table 1 provides some pseudo-code that calculates a discount for a given order as part of a process posting an order:

TABLE 1

void PostSalesOrder( )
{

```
  // Code that reads and prepares info on the sales order
  Order.Discount = CalculateDiscount(Order.Lines);
  // Post the order now that discount has been calculated
```

}
Decimal CalculateDiscount(Lines[ ] lines)
{

// Calculate the total amount of all lines
Decimal amount = 0;
foreach (lines l in lines)
{

amount += l.Price;

}
// Fixed 10% discount if amount is above 1000
if (amount > 1000)
{

return amount * 0.10;

}
return 0;

}

In the example set forth in Table 1, a developer tasked with providing a change to the 10% discount calculation may wish to provide a customization. For example, the developer may need to add an additional 5% discount if the total amount is greater than 2000. In order to provide a 15% discount to amounts above 2000, or 150% of the original discount if the amount is greater than 2000, the developer can define a customization as set forth in Table 2. This customization allows the behavior of the original code, set forth in Table 1, to be modified without changing the original code whatsoever.

TABLE 2
[HookMethod(“CalculateDiscount”,Run = AfterOriginal)]
Decimal MyOwnCalculateDiscount(Lines[ ] lines, OriginalScope _org)
{

if (_org.amount > 2000)
{

// If amount > 2000 increase discount 50%.
return _org._ReturnValue * 1.5;

}
return _org._ReturnValue;

}

The pseudo-code in Table 2 is associated with the original CalculateDiscount method provided in Table 1 by the HookMethod definition with the name of the original method. This HookMethod definition is defined in metadata. In the illustrated example, the definition is using an attribute in C# style syntax. However, this is only an example and any other suitable styles can be used. The association of the original method with the pseudo-code of Table 2, notifies the execution platform that the code of Table 2 is associated with original method set forth in Table 1. Additionally, by setting “Run=AfterOriginal”, the execution platform will execute the code of Table 2 after the code of Table 1 is executed. The declaration of the MyOwnCalculateDiscount now lists a parameter, lines, that is required to be present from the original method. Additionally, MyOwnCalculateDiscount sets the scope “OriginalScope _org” such that the customization will have access to parameters and variables from the original method. All usages of _org will be tracked by the execution platform and after compilation, the compiler will, in metadata, store an indication that MyOwnCalculateDiscount will be called in sequence with CalculateDiscount and that MyOwnCalculateDiscount will access lines (a parameter), amount (as a local variable) and ReturnValue (original returnvalue).

At runtime, execution platform 20 will now call MyOwnCalculateDiscount before returning from the original CalculateDiscount allowing MyOwnCalculateDiscount to provide virtually any desired customized function. The _org scope variable will actually refer the original variables.

Embodiments of the present invention are particularly useful where the original code is updated, patched, or simply changed by the original software publisher. For example, in Table 3, below, the original method CalculateDiscount has been revised to include customer and date information.

TABLE 3
Decimal CalculateDiscount(Customer customer, Date date, Lines[ ] lines)
{

```
// Calculate the total amount of all lines
  Decimal amount = 0;
  foreach (lines l in lines)
  {
```

amount += l.Price;

```
}
  // Do some calculation involving customer and date
  // and return the discount
  return xxx;
```

}

By virtue of the metadata stored relative to MyOwnCalculateDiscount, it is apparent that the prerequisites for MyOwnCalculateDiscount are still fulfilled in the changed source code. Specifically, the method CalculateDiscount still exists and it still has, among its parameters, a “Lines [ ] lines” parameter as well as a local variable named amount. The changes to the source code will thus not affect the “contract” defined by the developer for the customization. MyOwnCalculateDiscount will not be aware of, nor use the new parameters Customer or Date. However, MyOwnCalculateDiscount does not list such parameters as part of its contract. Thus, MyOwnCalculateDiscount will continue to function properly operating on amount and the return value. If, however, any of the items specified by the developer in the contract (such as the name of the method, the lines parameter or the amount variable) were changed or deleted in the updated source code, the contract would break and result in an error when applying the customization.

Of particular note in MyOwnCalculateDiscount, is the fact that the method is defined with the “Lines[ ] lines” parameter, but that the parameter is not used by MyOwnCalculateDiscount. However, by the developer still requiring “Lines[ ] lines” it has become part of the contract for the customization and accordingly needs to be part of the original signature. This is particularly advantageous where a developer, by doing this, can take dependencies on variables even though the customization does not require it. In other words, if the CalculateDiscount method is changed such that the lines are no longer required in the original method, the customization should break (i.e. be notified with an apply customization error) so that the developer can check the customization to see if the code is still valid. This allows the developer to define a contract as detailed (close to) the original code as desired. The more detail required in the contract, the greater the chance of a break when the original code is changed. The reverse is also true. Specifically, if a developer of the update to the original source code wishes to ensure that all customizations operating on Lines are required to revisit their customization, the developer could change the name of the variable, which would break the contract.

Table 4 (below) shows an example of some pseudo-code that is executed when CalculateDiscount is called:

TABLE 4
Decimal CalculateDiscount(Customer customer, Date date, Lines[ ] lines)
{

HookInMethod hook = GetHookMethod(“CalculateDiscount”);

if (hook != null)
{

hook.CallBefore(new object[ ] { this.customer, this.date,
lines });

}
// -------- Original method --------
// Calculate the total amount of all lines
Decimal amount = 0;
foreach (lines l in lines)
{

amount += l.Price;

```
}
// Do calculation involving customer and date and return the
discount
Decimal return Value = xxx;
// --------- end of original method -------
if (hook != null)
{
  returnValue = hook.CallAfter(new object[ ] { this.customer,
  this.date, lines, amount, returnValue });
}
return returnValue;
```

}

As can be seen, execution platform 20 will inject code to check if the method being called has been hooked and if so will pass all relevant information to the mechanism filtering the information and eventually calling the customization that is hooked to the method. The example shown in Table 4 is provided for purposes of illustration only, in an actual implementation, additional optimization may be employed and a “ReplaceOriginal” mechanism would also be provided.

All of the pseudo-code provided in the examples above is intended for illustration purposes only. Embodiments of the present invention can apply to any programming language that employs source code. Embodiments of the present invention, in some examples, provide a metadata-driven hook-in mechanism where the subscriber defines the contract vs. an author of the original source code. As long as the contract can be honored, upgrades and other changes can be made to the underlying source code without breaking the customization(s). Additionally, it is possible to determine whether such contracts can be honored simply by reviewing the metadata and the source code. Thus, the code does not need to be run before a break or other exception can be determined.

As set forth above, there are a number of ways in which the customization can be hooked to the original source code. The Run=AfterOriginal indication tells execution platform 20 that the original source code should run first followed by the customization. An alternative is Run=BeforeOriginal which will allow the customization to change any parameters and possible class variables before passing control to the original method. Still another is Run=ReplaceOriginal, which would cancel calls to the original source code and only call the customization. The latter could be used if the developer wishes to override the entire method. Indicating Run=ReplaceOriginal requires execution framework 20 to track changes made to the original code as breaking since the customization is now removing “unknown” code after a source code upgrade or change. Additionally, when using ReplaceOriginal, the _org variable should contain a CallOriginal method so that a call can be made to the original method if needed, after which the customization again will gain control and complete its work.

The code used in the customizations described herein is special in that all the constructs used by the code are “indirected” to underlying real variables where needed. Some of this can occur at compile-time and some of can occur at run-time. E.g. the code of the customization might access an Item table without having information about all the fields of such table. However, as long as the Item table has the field(s) used by the customization, the customization will function properly.

As can be appreciated, embodiments of the present invention are applicable to a wide variety of computing environments. The following are some examples of computing environments where embodiments of the present invention may be particularly advantageous.

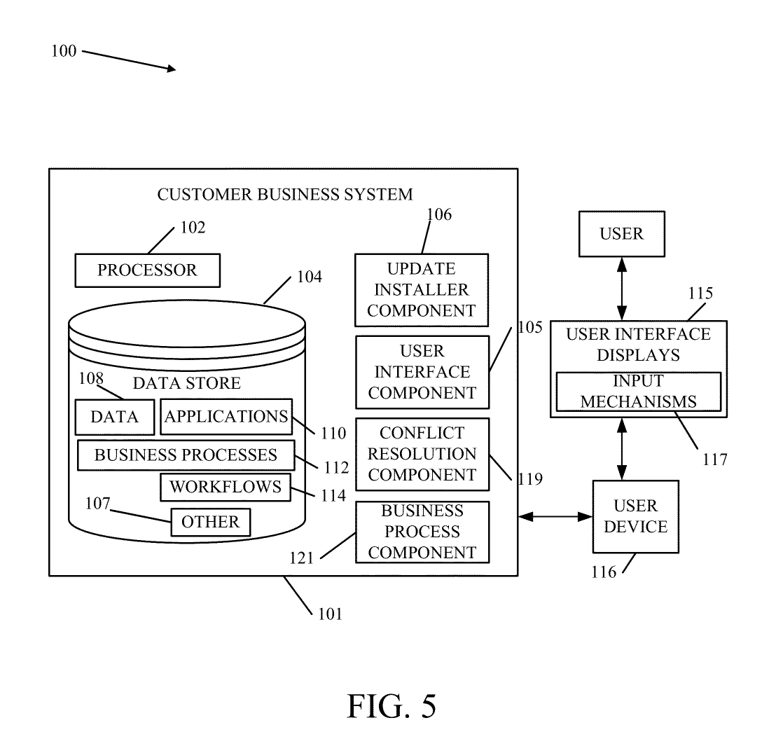

FIG. 5 shows a block diagram of one exemplary architecture in which embodiments described herein are useful. Architecture 100 includes customer business system 101 (which can be an on premise system, a cloud-based system, or another system). Business system 101 can be accessed by a user through user interfaces 115 generated either by business system 101 or by user device 116. In one embodiment, user interfaces 115 have user input mechanisms 117 that can be actuated by user 114 in order to manipulate business system 101.

Customer business system 101 illustratively includes processor 102, data store 104, user interface component 105, update installer component 106, conflict resolution component 119 and business process component 121. Data store 104 illustratively includes data 108, applications 110, information that describes business processes 112, information that describes workflows 114, and other items 107. In one embodiment, applications 110 include the business logic used to run business processes 112 and workflows 114 in business system 101. Applications 110 illustratively operate on data 108, which can include entities that represent items in the business system 101. Thus, applications 110 can include a general ledger application, inventory application, applications that allow a user to track business opportunities, track sales or production in a business system, or a wide variety of other business applications. The entities, for instance, include customer entities that represent customers, opportunity entities that represent business opportunities, inventory entities that represent inventory items, quote and proposal entities that represent quotes and proposals, etc. The data 108 can include a wide variety of other entities and data, and those mentioned above are mentioned for the sake of example only. The user can illustratively access customer business system 101 in order to perform activities, tasks, workflows, et cetera that are done in carrying out the business of the organization that employs business system 101.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

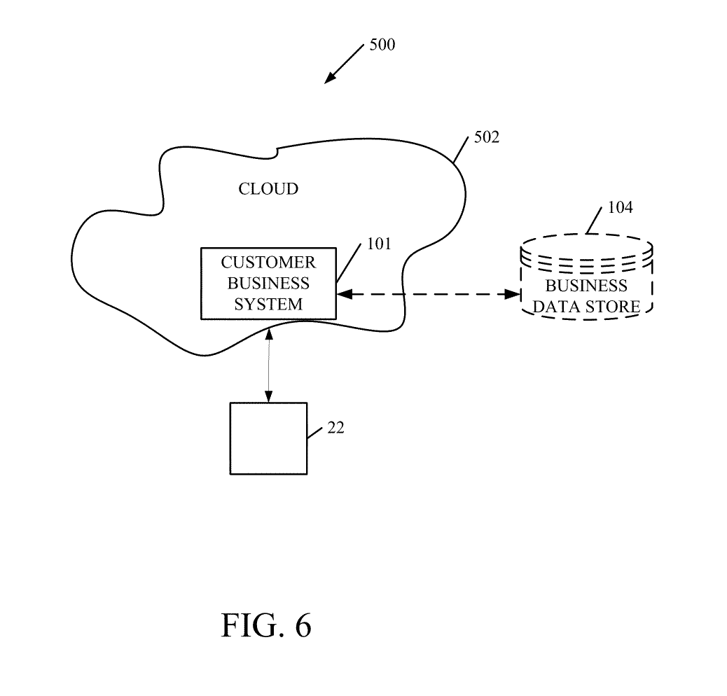

FIG. 6 is a block diagram of architecture 100, shown in FIG. 5, except that its elements are deployed in a cloud computing architecture 500. The term “cloud”, “cloud-based system”, “cloud-based architecture”, or similar terms refer to a network of devices (e.g. server computers, routers, etc.). Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 6, some items are similar to those shown in FIG. 5 and they are similarly numbered. FIG. 6 specifically shows that system 101 can be located in cloud 502 (which can be public, private, or a combination where portions are public while others are private). Therefore, the user uses a client device 22 to access those systems through cloud 502.

FIG. 6 also depicts another embodiment of a cloud architecture. FIG. 6 shows that it is also contemplated that some elements of architecture 100 are disposed in cloud 502 while others are not. By way of example, data store 104 can be disposed outside of cloud 502, and accessed through cloud 502. Regardless of where they are located, they can be accessed directly by client device 22, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be employed on a wide variety of different devices. Some of those devices include servers, desktop computers, laptop computers, tablet computers, or other mobile devices, such as palm top computers, cell phones, smart phones, multimedia players, personal digital assistants, etc.

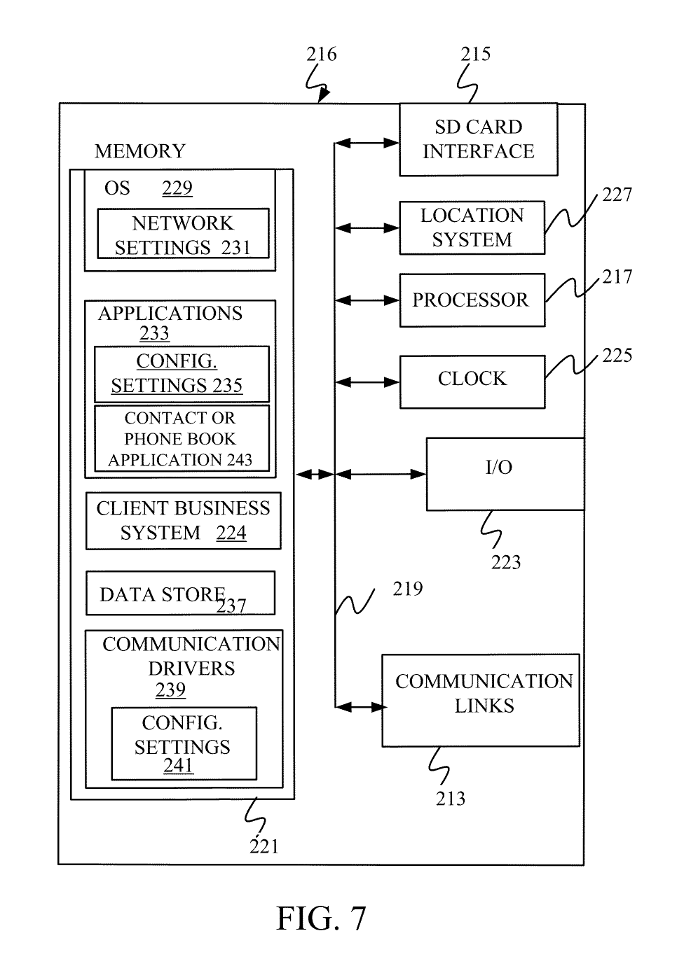

FIG. 7 is a simplified block diagram of one embodiment of a handheld or mobile computing device that can be used as a user's or client's hand held device 216, in which the present system (or parts of it) can be deployed. FIGS. 7-10 depict examples of handheld or mobile devices.

FIG. 7 provides a general block diagram of the components of a client device 216 that can run components of architecture 100 or that interacts with architecture 100. In device 216, a communications link 213 is provided that allows the handheld device to communicate with other computing devices and under some embodiments provides a channel for receiving information automatically, such as by scanning Examples of communications link 213 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

According to other embodiments, applications or systems are received on a removable Secure Digital (SD) card that is connected to a SD card interface 215. SD card interface 215 and communication links 213 communicate with a processor 217 along a bus 219 that is also connected to memory 221 and input/output (I/O) components 223, as well as clock 225 and location system 227.

I/O components 223, in one embodiment, are provided to facilitate input and output operations. I/O components 223 for various embodiments of the device 216 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 223 can be used as well.

Clock 225 illustratively comprises a real time clock component that outputs a time and date. It can also, illustratively, provide timing functions for processor 217.

Location system 227 illustratively includes a component that outputs a current geographical location of device 216. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 221 stores operating system 229, network settings 231, applications 233, application configuration settings 235, data store 237, communication drivers 239, and communication configuration settings 241. Memory 221 can include all types of tangible volatile and non-volatile computer-readable memory devices. It can also include computer storage media (described below). Memory 221 stores computer readable instructions that, when executed by processor 217, cause the processor to perform computer-implemented steps or functions according to the instructions. Processor 217 can be activated by other components to facilitate their functionality as well.

Examples of the network settings 231 include things such as proxy information, Internet connection information, and mappings. Application configuration settings 235 include settings that tailor the application for a specific enterprise or user. Communication configuration settings 241 provide parameters for communicating with other computers and include items such as GPRS parameters, SMS parameters, connection user names and passwords.

Applications 233 can be applications that have previously been stored on the device 216 or applications that are installed during use, although these can be part of operating system 229, or hosted external to device 216, as well.

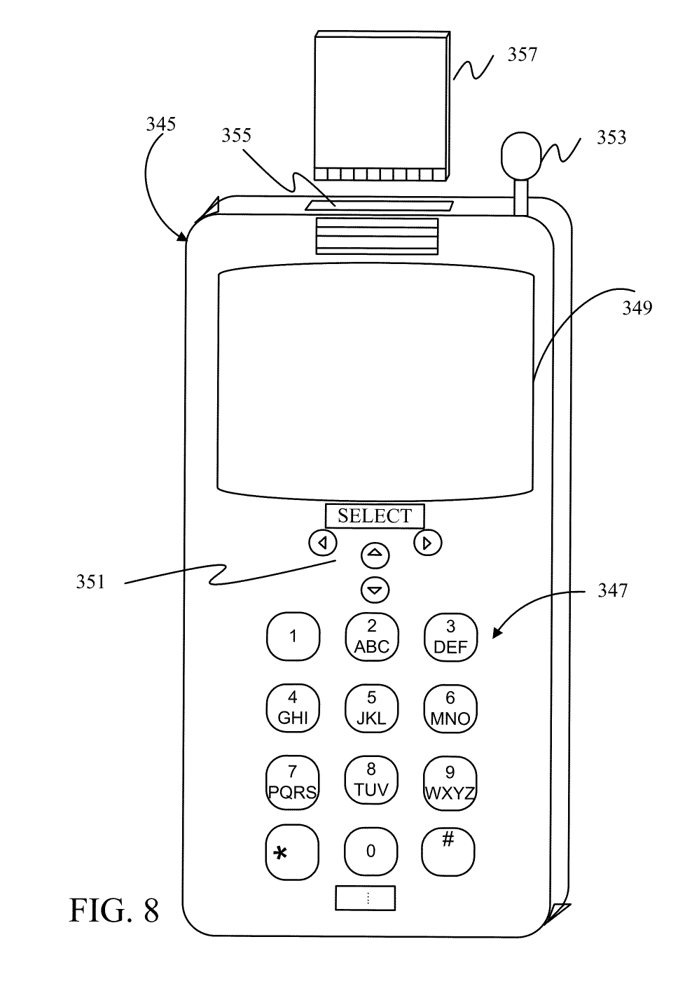

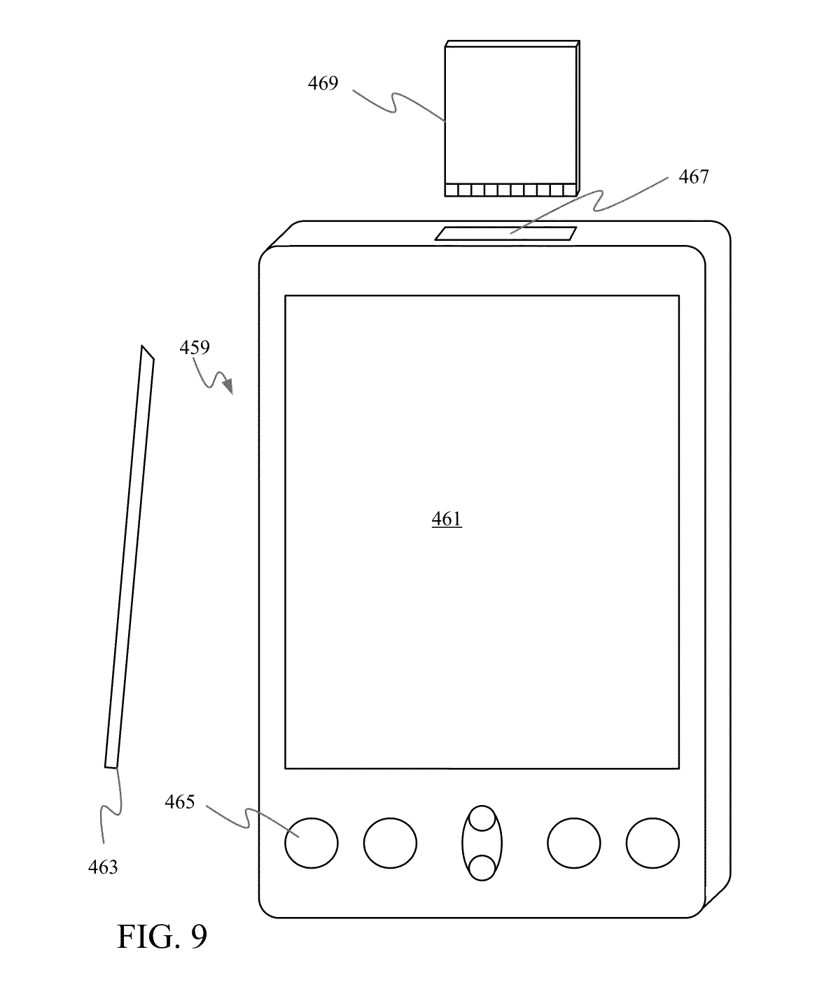

FIGS. 8 and 9 provide additional examples of devices 216 that can be used, although others can be used as well. In FIG. 8, a feature phone or mobile phone 345 is provided as the device 216. Phone 345 includes a set of keypads 347 for dialing phone numbers, a display 349 capable of displaying images including application images, icons, web pages, photographs, and video, and control buttons 351 for selecting items shown on the display. The phone includes an antenna 353 for receiving cellular phone signals such as General Packet Radio Service (GPRS) and 1×rtt, and Short Message Service (SMS) signals. In some embodiments, phone 345 also includes a Secure Digital (SD) card slot 355 that accepts a SD card 357.

The mobile device of FIG. 9 is a personal digital assistant (PDA) 459 or a multimedia player or a tablet computing device, etc. (hereinafter referred to as PDA 459). PDA 459 includes an inductive screen 461 that senses the position of a stylus 463 (or other pointers, such as a user's finger) when the stylus is positioned over the screen. This allows the user to select, highlight, and move items on the screen as well as draw and write. PDA 459 also includes a number of user input keys or buttons (such as button 465) which allow the user to scroll through menu options or other display options which are displayed on display 461, and allow the user to change applications or select user input functions, without contacting display 461. Although not shown, PDA 459 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 459 also includes a SD card slot 467 that accepts a SD card 469.

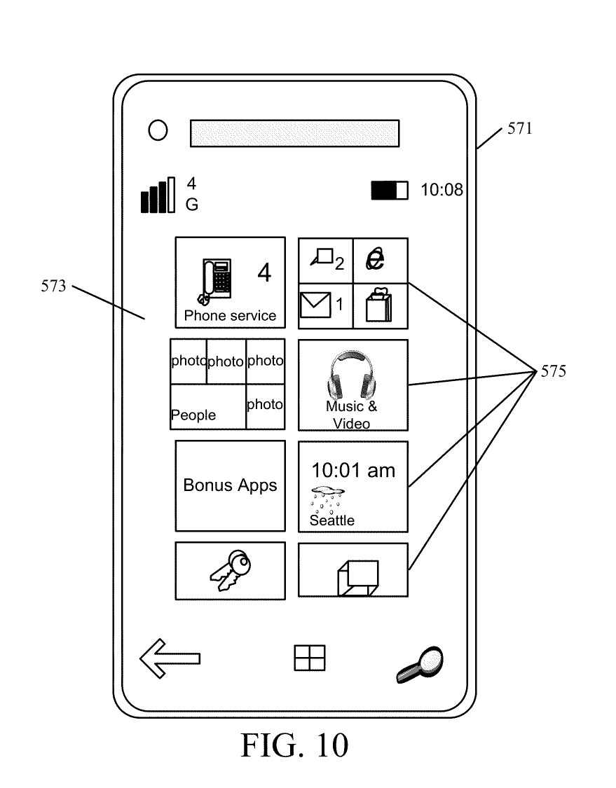

FIG. 10 is similar to FIG. 8 except that the phone is a smart phone 571. Smart phone 571 has a touch sensitive display 573 that displays icons or tiles or other user input mechanisms 575. Mechanisms 575 can be used by a user to run applications, make calls, perform data transfer operations, etc. In general, smart phone 571 is built on a mobile operating system and offers more advanced computing capability and connectivity than a feature phone

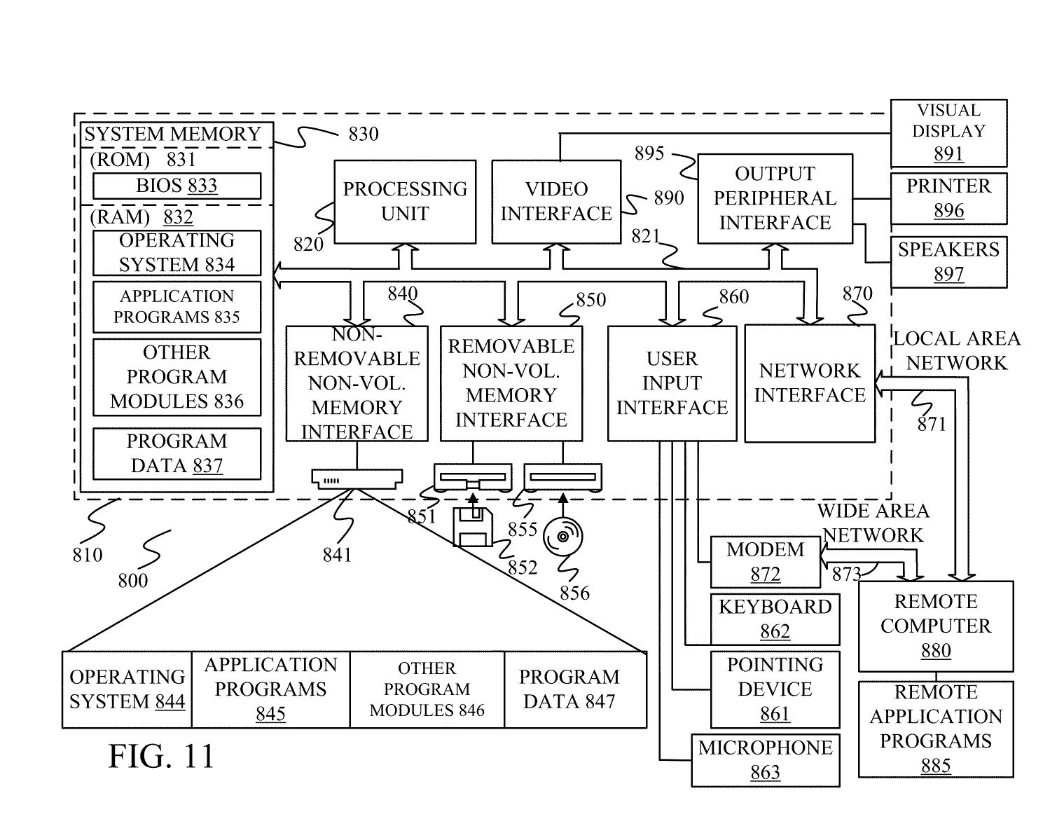

FIG. 8 through FIG. 10 illustrate particular forms of device 216 illustrated in FIG. 11. It should be appreciated that other forms of the devices 216, other than those shown in FIGS. 8-10, are possible.

FIG. 11 is one embodiment of a computing environment in which architecture 100, or parts of it, (for example) can be deployed. With reference to FIG. 11, an exemplary system for implementing some embodiments includes a general-purpose computing device in the form of a computer 810. Components of computer 810 may include, but are not limited to, a processing unit 820 (which can comprise processor 102 or the processor in system 200 or device 16), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computer-implemented method modifying execution behavior of a programmatic unit of source code. The method includes loading the programmatic unit of source code and determining whether at least one customization is defined for the programmatic unit. The at least one customization is selectively executed based on whether a prerequisite of the customization is satisfied.

Example 2 is a computer-implemented method of any or all of the previous examples, wherein the programmatic unit of source code is a single line of source code.

Example 3 is a computer-implemented method of any or all of the previous examples, wherein the programmatic unit of source code includes a plurality of lines of source code.

Example 4 is a computer-implemented method of any or all of the previous examples, wherein the programmatic unit of source code is a method.

Example 5 is a computer-implemented method of any or all of the previous examples, wherein the at least one customization selectively executes in place of the programmatic unit of source code.

Example 6 is a computer-implemented method of any or all of the previous examples, wherein the at least one customization selectively executes before the programmatic unit of source code.

Example 7 is a computer-implemented method of any or all of the previous examples, wherein the at least one customization selectively executes after the programmatic unit of source code.

Example 8 is a computer-implemented method of any or all of the previous examples, wherein selective execution of the at least one customization includes providing the at least one customization with access to variables of the programmatic unit of source code during execution.

Example 9 is a computer-implemented method of any or all of the previous examples, wherein the access is determined by a scope definition in the at least one customization.

Example 10 is a computer-implemented method of any or all of the previous examples, wherein the prerequisite includes the presence of a variable in the programmatic unit of source code.

Example 11 is a computer-implemented method of any or all of the previous examples, wherein the variable is not operated upon in the at least one customization.

Example 12 is a computer-implemented method of defining a customization relative to a programmatic unit of source code. The method includes identifying a programmatic unit of source code and specifying customization execution relative to the identified programmatic unit of source code. A scope of the customization execution is defined. The identification of the programmatic unit of source code, the specified customization execution information and scope information is stored and provided to an execution platform.

Example 13 is a computer-implemented method of any or all of the previous examples, and further defining at least one prerequisite that must be present in the programmatic unit of source code before the customization will be executed by the execution platform.

Example 14 is a computer-implemented method of any or all of the previous examples, wherein the prerequisite includes a parameter that must be present in the programmatic unit of source code before the customization will be executed by the execution platform.

Example 15 is a computer-implemented method of any or all of the previous examples, wherein the parameter is not used in the customization.

Example 16 is a computer-implemented method of any or all of the previous examples, wherein specifying customization execution relative to the identified programmatic unit of source code includes an indication that the customization will execute in place of the identified programmatic unit of source code.

Example 17 is a computer-implemented method of any or all of the previous examples, wherein the scope of the customization execution is defined so that the customization will have access to variable of the programmatic unit of source code that it is replacing.

Example 18 is a computer-implemented method of any or all of the previous examples, wherein specifying customization execution relative to the identified programmatic unit of source code includes an indication that the customization will execute absolutely first before the identified programmatic unit of source code.

Example 19 is a computer-implemented method of any or all of the previous examples, wherein specifying customization execution relative to the identified programmatic unit of source code includes an indication that the customization will execute absolutely last after the identified programmatic unit of source code.

Example 20 is a computer system configured to execute programmatic units of source code. The computer system includes a processor configured to execute the programmatic units of source code and a storage component adapted to store the programmatic units of source code and at least one customization defined relative to a selected programmatic unit of source code. The processor is configured to load a programmatic unit of source code and determine whether a customization is defined relative to the loaded programmatic unit of source code and selectively execute the customization based on a definition of the customization.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method of modifying execution behavior of a programmatic unit of source code, the method comprising:
loading the programmatic unit of source code;
determining whether at least one customization is defined for the programmatic unit;
accessing scope information providing access from the at least one customization to at least one variable in the programmatic unit of source code; and
selectively executing the at least one customization based on whether a prerequisite of the customization is satisfied.

2. The computer-implemented method of claim 1, wherein the programmatic unit of source code is a single line of source code.

3. The computer-implemented method of claim 1, wherein the programmatic unit of source code includes a plurality of lines of source code.

4. The computer-implemented method of claim 3, wherein the programmatic unit of source code is a method.

5. The computer-implemented method of claim 1, wherein the at least one customization selectively executes in place of the programmatic unit of source code.

6. The computer-implemented method of claim 1, wherein the at least one customization selectively executes before the programmatic unit of source code.

7. The computer-implemented method of claim 1, wherein the at least one customization selectively executes after of the programmatic unit of source code.

8. The computer-implemented method of claim 1, wherein selective execution of the at least one customization includes providing the at least one customization with access to variables of the programmatic unit of source code during execution.

9. The computer-implemented method of claim 8, wherein the access is determined by a scope definition in the at least one customization.

10. The computer-implemented method of claim 1, wherein the prerequisite includes the presence of a variable in the programmatic unit of source code.

11. The computer-implemented method of claim 10, wherein the variable is not operated upon in the at least one customization.

12. A computer-implemented method of defining a customization relative to a programmatic unit of source code, the method comprising:
identifying a programmatic unit of source code;
specifying customization execution relative to the identified programmatic unit of source code;
specifying a scope of the customization execution that provides access to at least one variable within the programmatic unit of source code;
storing the identification of the programmatic unit of source code, the specified customization execution information and scope information; and
providing the customization definition to an execution platform.

13. The computer-implemented method of claim 12, and further defining at least one prerequisite that must be present in the programmatic unit of source code before the customization will be executed by the execution platform.

14. The computer-implemented method of claim 13, wherein the prerequisite includes a parameter that must be present in the programmatic unit of source code before the customization will be executed by the execution platform.

15. The computer-implemented method of claim 14, wherein the parameter is not used in the customization.

16. The computer-implemented method of claim 12, wherein specifying customization execution relative to the identified programmatic unit of source code includes an indication that the customization will execute in place of the identified programmatic unit of source code.

17. The computer-implemented method of claim 16, wherein the scope of the customization execution is defined so that the customization will have access to variable of the programmatic unit of source code that it is replacing.

18. The computer-implemented method of claim 12, wherein specifying customization execution relative to the identified programmatic unit of source code includes an indication that the customization will execute absolutely first before the identified programmatic unit of source code.

19. The computer-implemented of claim 12, wherein specifying customization execution relative to the identified programmatic unit of source code includes an indication that the customization will execute absolutely last after the identified programmatic unit of source code.

20. A computer system configured to execute programmatic units of source code, the computer system comprising:
a processor configured to execute the programmatic units of source code;
a storage component adapted to store the programmatic units of source code and at least one customization defined relative to a selected programmatic unit of source code;
wherein the processor is configured to load a programmatic unit of source code and determine whether a customization is defined relative to the loaded programmatic unit of source code and selectively execute the customization based on a definition of the customization and scope information providing selective access to at least one variable in the selected programmatic unit of source code.
